(19) United States
(12) Patent Application Publication
(10) Pub. No.: US 2011/0308374 A1
(43) Pub. Date: Dec. 22, 2011

(54) Accordion Button assembly

(75) Inventor: Antonio Polverini, Porto Recanati (MC) (IT)

(73) Assignee: POLVERINI S.A.S. DI POLVERINI ANTONIO & C., Porto Recanati (MC) (IT)

(21) Appl. No.: 12/803,262

(22) Filed: Jun. 22, 2010

(30) Foreign Application Priority Data
Jun. 17, 2010 (IT) MI2010U000207

(51) Int. Cl. G10D 11/00

(52) U.S. Cl. 84/376 R

(57) ABSTRACT

An accordion button assembly construction, characterized in that said button assembly construction comprises a bottom body in which a top body is engaged, said bottom body comprising a substantially cylindric body including a top cavity.

### BACKGROUND OF THE INVENTION

The present invention relates to an accordion button assembly or construction.

As is known, an accordion is a musical aerophone instrument including a free reed bellows and comprising three main accordion parts: a sound box, on the singing side, that is at the player right hand, a bellow, at the center of the accordion, and a further sound box on the bass side, that is at the player left hand.

Depending on the keyboard type, it is possible to classify accordions into two main types that is: a “piano” or keyboard system, and a “chromatic” or button system.

A full piano accordion conventionally comprises 41 keys and 120 bass buttons.

Classical accordions may also comprise 45 keys.

A “chromatic” accordion, on the other hand, has a larger extension up to 52 “true” buttons, or more.

By pressing a key or a button, through a lever system a valve is raised allowing voice air to pass therethrough for producing a musical note corresponding to the pressed key or button.

Each button of the first two button rows, starting from the accordion bellows, that is the contrabass and bass rows, comprises a button rod on which is plugged a first pin which, through a corresponding linkage or lever system, opens the valves corresponding to a single note.

The chord buttons comprise on the driving rod either two or three small pins or pegs, for opening the valves of the corresponding chord.

In this latter years, the aesthetic aspect of the accordion has acquired an increasing importance.

In the early 19^{th} century, for example, accordions were not coated by outer coatings, and only few accordions were luxoriously constructed with wood an nacre inserts, thereby constituting true works of art.

Then, accordions have started to be coated by coating celluloid materials, in several colors, which celluloid materials, due to their brilliance and color fastness and inalterability, are still broadly used.

At present, anyhow, accordions are conventionally painted or coated by a lot of coating and decorating systems adapted to provide the instrument with a good aesthetical aspect.

To that end, the decoration of an accordion should meet both aesthetical, functional and structural requirements.

In other words, it is necessary to make accordion components which are both aesthetically pleasant and mechanical strength and of a long duration.

In fact, an accordion player carriers out his/her selection not only on the acoustical quality of the accordion, but also on its aesthetical aspect.

For example, a very important aesthetic requirement to be met is the performance of the instrument under reflectors used in plays, TV shows, ballrooms and so on.

### SUMMARY OF THE INVENTION

Thus, the aim of the present invention is to provide such an accordion button assembly which is also adapted to provide the accordion the button assembly is applied to with a pleasant aesthetic finishing.

Within the scope of the above mentioned aim, a main object of the invention is to provide such an accordion button assembly or construction which also has improved functional and structural characteristics.

Another object of the invention is to provide such an accordion button assembly which may be easily made and which, moreover, is very competitive from a mere economic standpoint.

Yet another object of the present invention is to provide such an accordion button assembly which has a small height, thereby perfectly mating to the sound box the button assembly is applied to.

This last object may be achieved by making the button assembly with a small height and including at the top thereof cavities for engaging mirror top bodies having a suitable color, brilliance and sheen, while preventing projecting steps from being formed and reducing to a minimum possible the level difference between the accordion surface and button assembly.

The top inserts may be made of a methacrylate material having any desired colors, for example the color of the button assembly body, and may be fixedly applied either by a mechanical screw coupling or a glued connection.

The insert on the top of the button may also have a pad shape and may be engaged in the rim delimiting the cavity formed in the top portion of the button.

As stated, the button assembly construction overcomes, from a functional standpoint, the problem of steps and gaps between the keyboard surface and button assemblies, while preserving the aesthetical advantages and the possibility of engaging in the top portions of the button assembly a pad mirror.

According to one aspect of the present invention, the above mentioned aim and objects, which will become more apparent hereinafter, are achieved by an accordion button assembly construction, characterized in that said button assembly construction comprise a bottom body therein is engaged a top body.

The bottom body comprises a substantially cylindric body, comprising a top cylindric cavity therein the top body is engaged.

The top body is advantageously made of a material having suitable color, brilliance and sheen characteristics, said materials being either a natural or a synthetic material.

The bottom body preferably comprises a material having suitable mechanical characteristics and adapted to be easily achieved, for example a plastics material.

Preferably, the top body may be made integral with the bottom body by a fixed coupling or by glue.

### BRIEF DESCRIPTION OF THE DRAWINGS

Further characteristics and advantages of the present invention will become more apparent hereinafter from the following description of a preferred, though not exclusive, embodiment of the invention, which is illustrated, by way of an indicative, but not limitative, example in the accompanying drawings, where:

FIG. 1 is a top perspective view of an accordion button assembly construction according to the present invention;

FIG. 2 is a further perspective view of the bottom body of the button assembly construction;

FIG. 3 is an elevation view of the bottom body of the subject button assembly construction;

FIG. 4 is a further cross-sectioned elevation view of the bottom body of the button assembly construction;

FIG. 5 is a top plan view of the bottom body of the subject button assembly construction;

FIG. 6 is a further perspective view showing an accordion portion including a plurality of button assemblies according to the present invention.

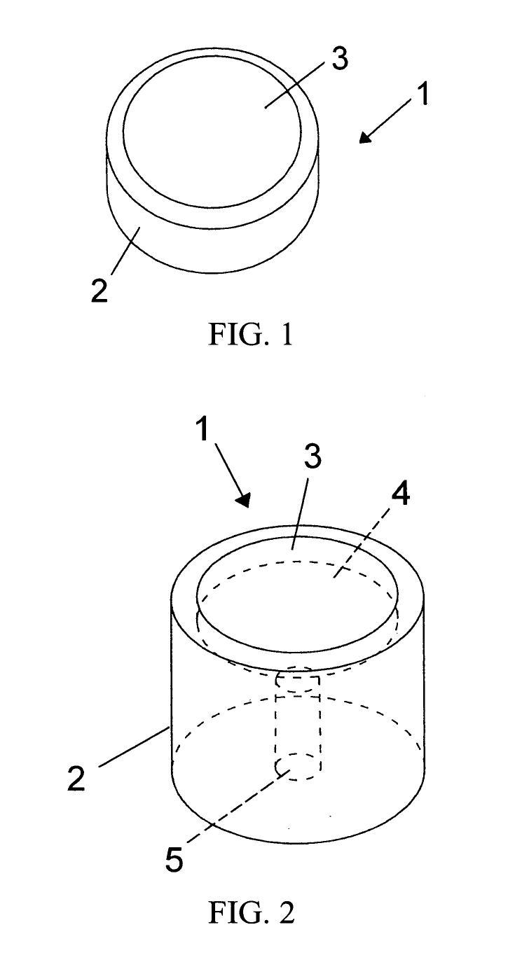

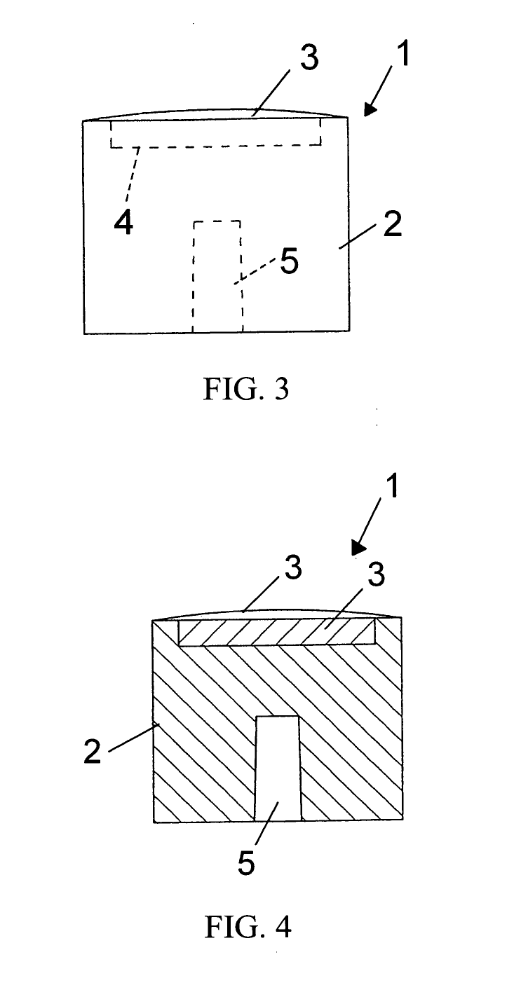

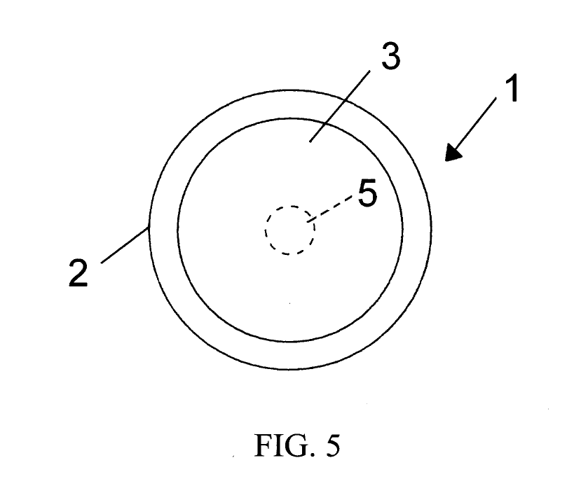

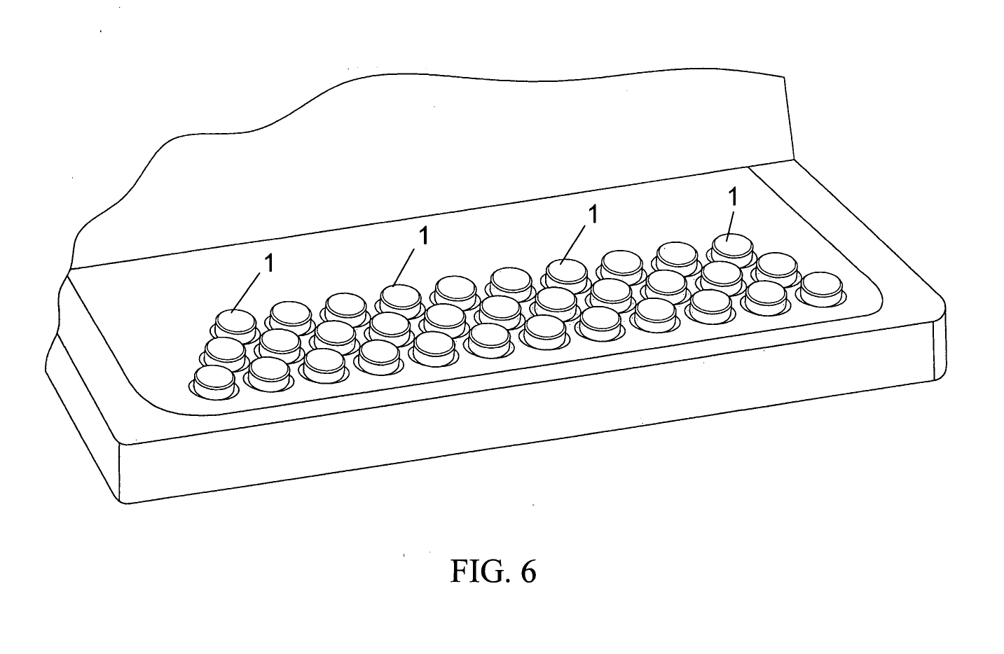

### DESCRIPTION OF THE PREFERRED EMBODIMENT

With reference to the number references of the above mentioned figures, the button assembly construction, according to the present invention, which has been generally indicated by the reference number 1, comprises a button bottom body 2, therein a button top body 3 is engaged.

The button bottom body 2 comprises a substantially cylindric body including a top cylindric recess 4 for housing said top body 3.

At the bottom thereof, said bottom body 2 comprises a substantially axially extending blind hole 5 for receiving the top end portion of a rod element, not shown in the figures, coupled to the respective voice assembly, that is to the accordion sound generating system.

The top body 3 is advantageously made of a material having any suitable color, brilliance and sheen characteristics, which may be either a natural or a plastics material.

Said bottom body 2 is also preferably made of a plastics material.

The top body 3 may be made rigid or integral with said bottom base 2 by a forced coupling, or may be glued to the bottom body 2, or may be fixedly coupled to the latter by any other suitable coupling systems.

The button assembly 1 comprises moreover, according to an important aspect to the invention, a top cavity or recess 4 having a diameter less than that of the button 1 bottom body, thereby defining top projecting edges 6, for engaging the mentioned top body 3 which may comprise a mirror pattern.

Thus, notwithstanding the application of said mirror top body 3, the inventive button 1 has a small height, with the above mentioned functional and aesthetic advantages.

It has been found that the invention fully achieves the intended aim and objects.

In fact, the invention has provided an accordion button assembly construction having a bottom body, which constitutes the button supporting strong element of the button structure, made of inexpensive and easily machined materials, whereas the button proper, which constitutes the part thereof exposed to the view, is of a material having good aesthetic brilliance and coloring characteristics.

1. An accordion button assembly construction, characterized in that said button assembly construction comprises a bottom body in which a top body is engaged, said bottom body comprising a substantially cylindric body including a top cavity.

2. An accordion button assembly construction, according to claim 1, characterized in that said bottom body comprises a substantially axially extending bottom blind hole therein is engaged a top portion of a rod coupled to an accordion sound generating system.

3. An accordion button assembly construction, according to claim 1, characterized in that said top body is made either of a natural or synthetic brilliant material.

4. An accordion button assembly construction, according to claim 1, characterized in that said bottom body is made of a plastics material.

5. An accordion button assembly construction, according to claim 1, characterized in that said top body is a mirror top body which is fixedly coupled to said bottom body by a forced coupling or a glueing system.
